(19) United States
(12) Patent Application Publication
(10) Pub. No.: US 2026/0244906 A1
(43) Pub. Date: Aug. 20, 2026

(54) MEMORY ACCESS ADAPTIVE SELF-ATTENTION MECHANISM FOR TRANSFORMER MODEL

(71) Applicant: Intel Corporation, Santa Clara, CA (US)

(72) Inventors: Ganmei YOU, Beijing (CN); Li XU, Shanghai (CN)

(73) Assignee: Intel Corporation, Santa Clara, CA (US)

(21) Appl. No.: 18/995,099

(22) PCT Filed: Oct. 28, 2022
(86) PCT No.: PCT/CN2022/128330

§ 371 Date: Jan. 15, 2025

(51) Int. Cl. G06N 3/0495; G06F 13/16

(52) U.S. Cl. CPC G06N 3/0495; G06F 13/1689

(57) ABSTRACT

The application relates to a memory access adaptive self-attention mechanism for a Transformer model. A method may include: estimating first execution time of selecting a number k of dominant data elements from an initial self-attention input matrix for a Transformer model to generate a sparse self-attention input matrix; estimating second execution time of performing a self-attention operation for the Transformer model based on the sparse self-attention input matrix; estimating third execution time of performing the self-attention operation based on the initial self-attention input matrix; and performing the self-attention operation based on the first execution time, the second execution time and the third execution time.

### TECHNICAL FIELD

Embodiments described herein generally relate to neural network technology, and more particularly relate to a memory access adaptive self-attention mechanism for a Transformer model.

### BACKGROUND

Time-series forecasting is a critical ingredient across many domains, such as sensor network monitoring, energy and smart grid management, economics and finance, and disease propagation analysis, etc. In these scenarios, a substantial amount of time-series data on past behaviors may be used to make a forecast in the long run, namely long sequence time-series forecasting (LSTF). Transformer models have superior performance in capturing long-range dependency than Recurrent Neural Network (RNN) models. A self-attention mechanism for the Transformer models can reduce a maximum length of traveling paths of network signals and avoid recurrent structures, thereby the Transformer models show great potential for LSTF problems.

### BRIEF DESCRIPTION OF THE DRAWINGS

The various advantages of the embodiments will become apparent to one skilled in the art by reading the following specification and appended claims, and by referencing the following drawings, in which:

FIG. 1 illustrates an example procedure for determining a self-attention operation for a Transformer model according to some embodiments of the present disclosure;

FIG. 2 illustrates another example procedure for determining a self-attention operation for a Transformer model according to some embodiments of the present disclosure;

FIG. 3A illustrates pseudo codes of an example matrix multiplication algorithm according to some embodiments of the present disclosure;

FIG. 3B illustrates pseudo codes of an example top-k data selection algorithm for generating a sparse self-attention input matrix according to some embodiments of the present disclosure;

FIG. 3C illustrates an example procedure of an example self-attention operation based on a sparse self-attention input matrix obtained by an example top-k data selection algorithm according to some embodiments of the present disclosure;

FIG. 4 illustrates a flowchart of an example procedure for implementing a memory access adaptive self-attention operation for a Transformer model according to some embodiments of the present disclosure;

FIG. 5 is a block diagram of an example processor platform structured to execute and/or instantiate machine readable instructions and/or operations to implement example procedures according to some embodiments of the present disclosure;

FIG. 6 is a block diagram of an example implementation of the processor circuitry of FIG. 5.

FIG. 7 is a block diagram of another example implementation of the processor circuitry of FIG. 5.

### DETAILED DESCRIPTION

Various aspects of the illustrative embodiments will be described using terms commonly employed by those skilled in the art to convey the substance of the disclosure to others skilled in the art. However, it will be apparent to those skilled in the art that many alternate embodiments may be practiced using portions of the described aspects. For purposes of explanation, specific numbers, materials, and configurations are set forth in order to provide a thorough understanding of the illustrative embodiments. However, it will be apparent to those skilled in the art that alternate embodiments may be practiced without the specific details. In other instances, well-known features may have been omitted or simplified in order to avoid obscuring the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

Transformer models have shown superior performance in capturing long-range dependency and are widely used for solving LSTF problems. Though canonical Transformer models have greatly improved accuracy in LSTF, an inference speed of the Transformer models is still a problem for those high-performance applications such as network traffic forecasting.

One main reason of the limited inference speed lies in matrix computations involved in a self-attention operation of the Transformer model. To decrease the time of matrix computations, top-k data selection based sparse self-attention algorithms have been applied to some evolved Transformer models. These algorithms can create a sparse self-attention input matrix by selecting a part of an initial self-attention input matrix and then compute a sparse approximation of a self-attention operation for the Transformer model. The value of k may determine the matrix computation complexity of the self-attention operation. However, current methods for selecting the value of k do not consider additional time such as memory access time and computation time that the selection of the value k brings, which sometimes may be higher than reduced matrix multiplication time. As a result, the whole execution time of the self-attention operation based on a sparse self-attention input matrix may increase compared with that of the canonical self-attention operation based on the initial self-attention input matrix, and then the corresponding execution time of the Transformer model may increase.

In view of this issue, according to some embodiments in the disclosure, it is proposed to compare the total execution time of the top-k data selection for generating the sparse self-attention input matrix and the self-attention operation based on the sparse self-attention input matrix and the execution time of the canonical self-attention operation based on the initial self-attention input matrix for the Transformer model, and determine whether to perform the self-attention operation for the Transformer model based on the sparse self-attention input matrix or the initial self-attention input matrix.

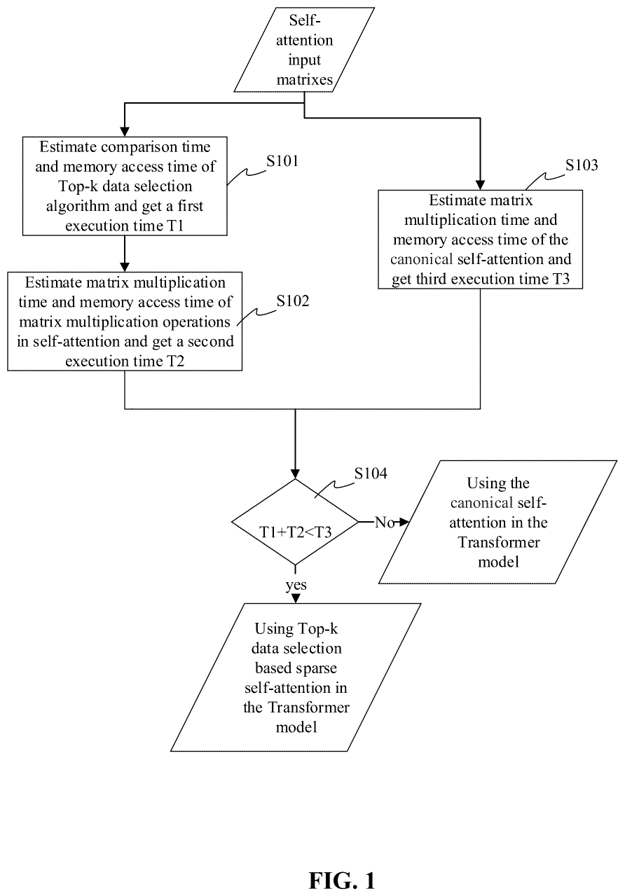

FIG. 1 illustrates an example procedure for determining a self-attention operation for a Transformer model according to some embodiments of the present disclosure. As shown in FIG. 1, given initial self-attention input matrixes for the Transformer model, for example, a query matrix Q, a key matrix K and a value matrix V, the first execution time T1 of top-k data selection for generating the sparse self-attention input matrix may be estimated based on a top-k data selection algorithm applied to the Transformer model at step S101; the second execution time T2 of performing a self-attention operation for the Transformer model based on the sparse self-attention input matrix may be estimated at step S102; the third execution time T3 of performing the self-attention operation based on the initial self-attention input matrix may be estimated at step S103; and the sum of the first execution time T1 and the second execution time T2 may be compared with the third execution time at step S104 to determine whether to perform the self-attention operation for the Transformer model based on the sparse self-attention input matrix (i.e. using top-k data selection based sparse self-attention in the Transformer model) or perform the self-attention operation for the Transformer model based on the initial self-attention input matrix (i.e. using the canonical self-attention in the Transformer model).

It is noted that the top-k data selection algorithm applied to the Transformer model may be any existing or future algorithm of selecting a number k of dominant data elements from the initial self-attention input matrix to generate the sparse self-attention input matrix.

For example, a transformer-based model for LSTF, named Informer, is proposed by Zhou, H., Zhang, S., Peng, J., Zhang, S., Li, J., Xiong, H., and Zhang, W. in “Informer: Beyond efficient transformer for long sequence time series forecasting”, arXiv:2012.07436, Mar. 28, 2021. In the Informer, a Probability Sparse (ProbSparse) self-attention mechanism is proposed to efficiently replace the canonical self-attention mechanism, which computes a query's attention probability distribution on specific data and then selects the number of the dominating queries as the value of k for the top-k data selection to get a sparse self-attention input matrix that approximates the initial self-attention input matrix.

The ProbSparse self-attention mechanism achieves the O(L log L) time complexity in matrix computation. Compared with the O(L²) time complexity of the canonical self-attention in matrix computation, the ProbSparse self-attention mechanism may improve the matrix computation performance greatly. However, the Informer does not consider the memory access time and computation time that the top-k data selection algorithm brings. The whole execution time of the Informer may be longer than that of the Transformer model with the canonical self-attention mechanism in some cases. According to the example procedure shown in FIG. 1, the total execution time of the ProbSparse self-attention operation including the memory access time and comparison time associated with the top-k data selection may be estimated and compared with the execution time of the canonical self-attention operation using the initial self-attention input matrix, so as to determine whether to use the ProbSparse self-attention operation or the canonical self-attention operation in the Transformer model.

In another example, a Query Selector transformer model is proposed by Jacek Klimek, Jakub Klimek, Witold Kraskiewicz, and Mateusz Topolewski, in “Long-term series forecasting with Query Selector-efficient model of sparse attention”, arXiv: 2107.08687v1, Jul. 19, 2021. The Query Selector chooses a predefined number l of queries that give the biggest scalar products with keys, replaces the usual self-attention input matrix K with a column-constant matrix K′ of elements equal to the mean value of l greatest elements in the column of K, and constructs Q′ by choosing l rows of the usual self-attention input matrix Q with indices equal to indices of l columns of K′ with the highest common value of the given column and setting the remaining rows to zero. In this way, the generated sparse self-attention input matrix may be used in the self-attention operation for the Transformer model.

In the Query Selector transformer model, though a predefined number l is used in the top-k data selection algorithm to make the self-attention input matrix sparse and then accelerate the matrix multiplication computation, the top-k data selection algorithm brings a lot of memory access time and additional computation time. As a result, the whole execution time of the Query Selector transformer model may be longer than that of the Transformer model with the canonical self-attention mechanism in some cases. According to the example procedure shown in FIG. 1, the total execution time of the self-attention operation based on the generated sparse self-attention input matrix including the memory access time and comparison time associated with the top-k data selection may be estimated and compared with the execution time of the canonical self-attention operation without using the sparse self-attention input matrix, so as to determine whether to use the self-attention operation based on the generated sparse self-attention input matrix or the canonical self-attention operation in the Transformer model.

According to some embodiments of the present disclosure, the value of k may be a variable and may be selected to minimize the sum of the first execution time of top-k data selection for generating the sparse self-attention input matrix and the second execution time of performing the self-attention operation for the Transformer model based on the sparse self-attention input matrix and meanwhile ensure that a preset accuracy is satisfied.

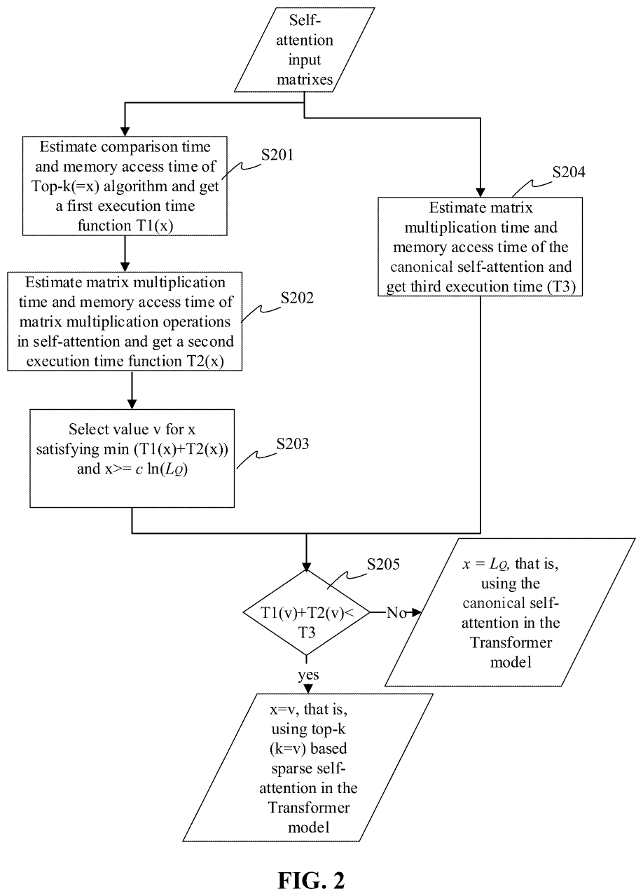

FIG. 2 illustrates another example procedure for determining a self-attention operation for a Transformer model according to some embodiments of the present disclosure. In the example procedure of FIG. 2, the value of k is supposed to be a variable x and steps S201 to S205 may be performed to achieve a Transformer model with a high speed and a high accuracy for inference.

At step S201, the first execution time function T1(x) of top-k data selection for generating the sparse self-attention input matrix may be estimated based on a top-k data selection algorithm applied to the Transformer model. At step S202, the second execution time T2(x) of performing a self-attention operation for the Transformer model based on the sparse self-attention input matrix may be estimated. At step S203, the value of k may be selected to minimize a sum of T1(x) and T2(x) while a preset accuracy is satisfied. For example, k may be larger than or equal to c×lnL_{Q}, where c is a constant sampling factor and L_{Q} is a row number of an input query matrix for the Transformer model. It has been proved that k>=c×lnL_{Q} may ensure the accuracy of the Transformer model when using the top-k data selection based sparse self-attention. For example, the constant sampling factor e may be set to be 2 or a greater number. Supposing that when the value of k is equal to v (i.e. x=v), the sum of T1(x) and T2(x) is the minimum. At step S204, the third execution time T3 of performing the self-attention operation based on the initial self-attention input matrix may be estimated; and at step S205, the sum of T1(v) and T2(v) may be compared with the third execution time T3 to determine whether to perform the self-attention operation for the Transformer model based on the sparse self-attention input matrix (i.e. x=v, using top-k (k=v) data selection based sparse self-attention in the Transformer model) or perform the self-attention operation for the Transformer model based on the initial self-attention input matrix (i.e. using the canonical self-attention in the Transformer model, that is, x=L_{Q}).

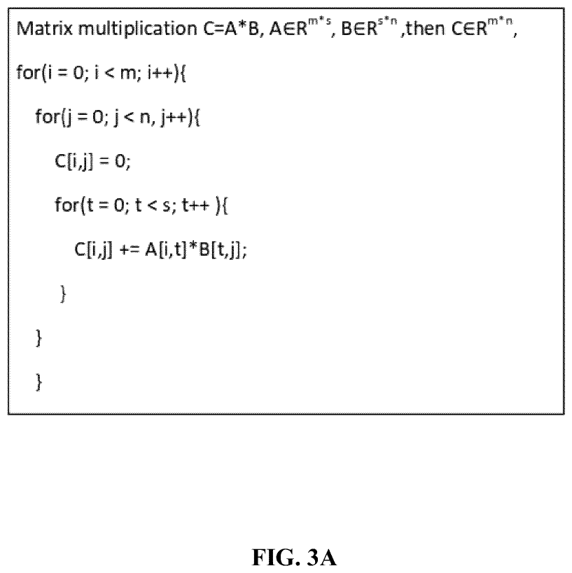

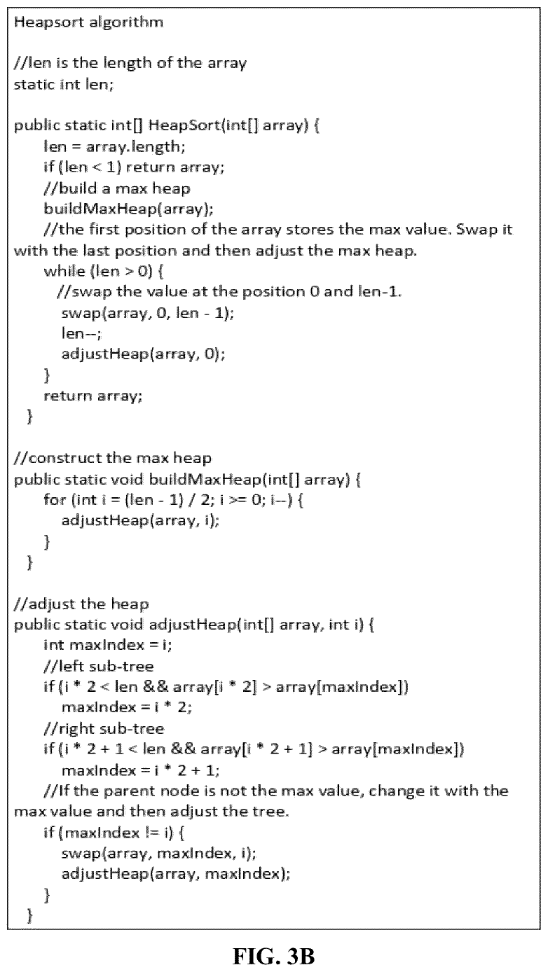

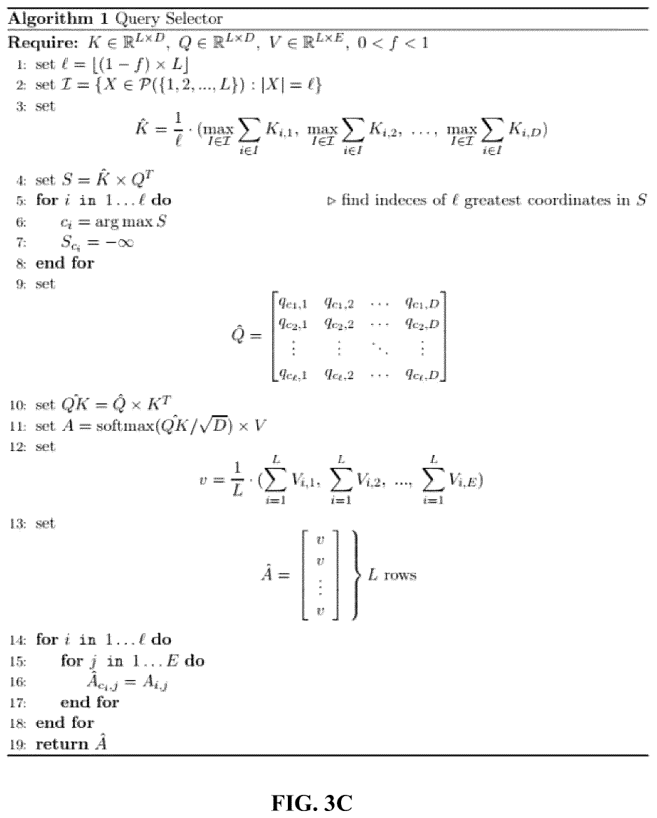

Next, an example embodiment is provided to illustrate how to estimate the execution time of the self-attention operation for the Transformer model with reference to the example codes shown in FIG. 3A to FIG. 3C.

In the following description, T_{memory} may indicate the time for each data transfer between memory and register, T_{compare} may indicate the time for comparison of two data elements, T_{multiply} may indicate the time for multiplication of two data elements, T_{add} may indicate the time for adding two data elements. All the time can be gotten from tests on a hardware platform where the Transformer model operates.

FIG. 3A illustrates pseudo codes of a general matrix multiplication algorithm. During the execution of the code C[i,j]+=A[i, t]*B[t, j], the operations may include loading A[i,t] and B[t, j] into memory, multiplying A[i,t] and B[t, j], adding the multiplication result to C[i,j] and then storing C[i,j] to the memory. That is, the execution of the code C[i,j]+=A[i, t]*B[t, j] may include three memory access operations, one multiplication operation, and one add operation, so the execution time of s times of the code C[i,j]+=A[i, t]*B[t, j] may be calculated as follows.

$${T}_{c [ i , j ]} = s * ( 3 * {T}_{memory} + {T}_{multiply} + {T}_{add} )$$

Thus the total execution time of T_{matrix_multiply} of the matrix multiplication (C=A*B) may be calculated as m*n*T_{c[i,j]} and represented by the following equation.

$${T}_{matrix \_ multiply} = m * n * s * ( 3 * {T}_{memory} + {T}_{multiply} + {T}_{add} ) \qquad ( Equation 1 )$$

As described above, the execution time of top-k data selection for generating the sparse self-attention input matrix may be estimated based on a top-k data selection algorithm applied to the Transformer model, Top-k data selection algorithms can be constructed from sort algorithms to select k dominate data elements. The classic sort algorithms include BubbleSort, QuickSort and HeapSort, etc. Each algorithm has different time complexity of sorting. To estimate the execution time of the top-k data selection, three main operations such as loading data elements from memory, storing data elements to memory, and comparing data elements may be considered. For each sort operation, it may be necessary to load two data elements from memory to registers respectively and then compare them.

Taking the HeapSort algorithm as an example, the estimation of the execution time of the top-k data selection may be described with reference to FIG. 3B which illustrates pseudo codes of the HeapSort algorithm. Suppose a length of an array to be sorted is L, and a number k of dominate data elements are to be selected from the array. If k>=L, all the data elements of the array will be selected, and no selection operation is needed. If k<L, firstly a heap with k data elements may be built. The time complexity of building the heap may be O(k*log k). For each comparison of two data elements, four times of memory access may be needed, which includes loading the two data elements from memory and storing the two data elements to the memory, So the time complexity of the total memory access for building the heap may be O(4*k*log k), For the left (L−k) data elements, the time complexity of comparison may be O(L−k)*log k). Then the complexity of the memory access may be O(4*(L−k)*log k). So the total execution time of the top-k data selection algorithm for one column of the matrix may be estimated as follows.

$${T}_{topk \_ column} = ( k * log k + ( L - k ) * log k ) * {T}_{compare} + ( 4 * k * log k + 4 * ( L - k ) * log k ) * {T}_{memory}$$

$${T}_{topk \_ column} = L * log k * {T}_{compare} + 4 * L * log k * {T}_{memory}$$

Since the self-attention input matrix A (e.g. the query matrix) may include D columns, the first execution time of the top-k data selection algorithm for the matrix may be estimated by the following equation.

$${T}_{matrix \_ top - k} = D * ( L * log k * {T}_{compare} + 4 * L * log k * {T}_{memory} ) \qquad ( Equation 2 )$$

In addition to the first execution time of top-k data selection for generating the sparse self-attention input matrix, the second execution time of performing a self-attention operation for the Transformer model based on the sparse self-attention input matrix needs to be estimated so as to get the total execution time of the top-k data selection based sparse self-attention operation. The estimation of the second execution time and the total execution time of the top-k data selection based sparse self-attention operation may be described with reference to FIG. 3C which illustrates an example procedure of an example self-attention operation based on a sparse self-attention input matrix obtained by an example top-k data selection algorithm according to some embodiments of the present disclosure.

As shown in FIG. 3C, the Query Selector described in “Long-term series forecasting with Query Selector-efficient model of sparse attention” by Jacek Klimek, Jakub Klimek, Witold Kraskiewicz, and Mateusz Topolewski, arXiv: 2107.08687v1, Jul. 19, 2021 may be taken as an example model to illustrate the estimation of the execution time of performing the top-k data selection based self-attention operation.

To estimate the total execution time of the top-k data selection based sparse self-attention operation, the main time cost of the algorithm shown in FIG. 3C may be calculated, e.g., calculating the execution time of top-k selection on line 3, and matrix multiplication on line 4, line 10 and line 11.

The code on line 3 selects k (=l) dominate data elements and accumulates them for each column, and the execution time may be represented by Tₕᵢₙₑ₃=T_{matrix_top-k}+T_{add}*l*D. Based on Equation 2, the execution time of the code on line 3 may be calculated as follows.

$${T}_{line 3} = D * ( L * log l * {T}_{compare} + 4 * L * log l * {T}_{memory} ) + {T}_{add} * l * D$$

The code on line 4 is the matrix multiplication of the sparse key matrix \hat{K}∈R^{l×D} and the transpose of the query matrix Q∈R^{L×D}. Based on Equation 1, the execution time of the code on line 4 may be calculated as follows.

$${T}_{line 4} = l * D * L * ( 3 * {T}_{memory} + {T}_{multiply} + {T}_{add} )$$

The code on line 10 is the matrix multiplication of the sparse query matrix \hat{Q}∈R^{l×D} and the key matrix K∈R^{L×D}. Based on Equation 1, the execution time of the code on line 10 may be calculated as follows.

$${T}_{line 10} = l * D * L * ( 3 * {T}_{memory} + {T}_{multiply} + {T}_{add} )$$

The main time cost of the code on line 11 is the execution time of the matrix multiplication of \hat{Q}K∈R^{i×L} and the value matrix V∈R^{L×E}. Based on Equation 1, the execution time of the code on line 11 may be calculated as follows.

$${T}_{line 11} = l * E * L * ( 3 * {T}_{memory} + {T}_{multiply} + {T}_{add} )$$

As a result, the total main time cost of the top-k data selection based sparse self-attention operation may be estimated as T_{sparse_self-attention}=Tₗᵢₙₑ₃+Tₗᵢₙₑ₄+Tₗᵢₙₑ₁₀+Tₗᵢₙₑ₁₁, and re resented by the following equation.

$${T}_{sparse \_ self - attention} ( l ) = D * ( L * log l * {T}_{compare} + 4 * L * log l * {T}_{memory} ) + {T}_{add} * l * D + l * L * ( 2 * D + E ) * ( 3 * {T}_{memory} + {T}_{multiply} + {T}_{add} ) \qquad ( Equation 3 )$$

In some embodiments, the value of k(=l) in Equation 3 may be a variable and may be selected to minimize the estimated total execution time of the top-k data selection based sparse self-attention operation and meanwhile ensure that a preset accuracy is satisfied. That is, the value for l may be selected to get the minimum value of T_{sparse_self-attention} as represented by Equation 3 under the condition l>=c*lnL_{Q}, where c is a constant sampling factor and L_{Q} is a row number of the input query matrix for the Transformer model. It has been proved in “Informer: Beyond efficient transformer for long sequence time series forecasting” by Zhou, H., Zhang, S., Peng, J., Zhang, S., Li, J., Xiong. H., and Zhang, W., arXiv:2012.07436, Mar. 28, 2021, that when l>=c×lnL_{Q}, the accuracy of a Transformer model with the top-k data selection based sparse self-attention will not be lower than that of the Transformer model with the canonical self-attention. For example, the constant sampling factor c may be set to be 2. That is, l>=2lnL_{Q}.

Based on Equation 3, when l=2lnL_{Q}, the minimum value of T_{sparse_self-attention} can be obtained and represented as follows.

$$min ( {T}_{sparse \_ self - attention} ( l ) ) = {T}_{sparse \_ self - attention} ( 2 ln {L}_{Q} ) = D * ( L * log ( 2 ln {L}_{Q} ) * {T}_{compare} + 4 * L * log ( 2 ln {L}_{Q} ) * {T}_{memory} ) + {T}_{add} * 2 ln {L}_{Q} * D + 2 ln {L}_{Q} * L * ( 2 * D + E ) * ( 3 * {T}_{memory} + {T}_{multiply} + {T}_{add} )$$

Next, the third execution time of performing the canonical self-attention operation (Q*K^{T}/\sqrt{d})*V based on the initial self-attention input matrix may be estimated by calculating and summing the matrix multiplication time and memory access time of the canonical self-attention operation (Q*K^{T}/\sqrt{d})*V. Based on Equation 1, the third execution time of performing the canonical self-attention operation may be represented as follows.

$${T}_{canonical self - attention} = L * D * L * ( 3 * {T}_{memory} + {T}_{multiply} + {T}_{add} ) + L * E * L * ( 3 * {T}_{memory} + {T}_{multiply} + {T}_{add} ) = L * L * ( D + E ) * ( 3 * {T}_{memory} + {T}_{multiply} + {T}_{add} )$$

Then the min(T_{sparse_self-attention}(l)) and the T_{canonical_self-attention} may be compared to determine whether to perform the top-k data selection based sparse self-attention operation for the Transformer model or perform the canonical self-attention operation for the Transformer model. If the min(T_{sparse_self-attention}(l)) is less than the T_{canonical_self-attention}, the value of l for getting the min(T_{sparse_self-attention}(l)) may be set as the value of k for the top-k data selection and the top-k data selection based sparse self-attention operation may be performed for the Transformer model, or otherwise, the canonical self-attention operation (Q*K^{T}/\sqrt{d})*V based on the initial self-attention input matrix may be performed for the Transformer model.

After selecting an appropriate self-attention mechanism for the Transformer model, the Transformer model with the selected self-attention mechanism may be trained to get weights for the model and then utilized for inference with high accuracy and high speed.

As illustrated above, the embodiments of the present disclosure may provide the Transformer model with high accuracy and high speed for inference based on comparison of the total execution time including memory access time of the top-k data selection based sparse self-attention operation and the execution time of the canonical self-attention operation. In other words, a memory access adaptive self-attention mechanism is proposed for the Transformer model.

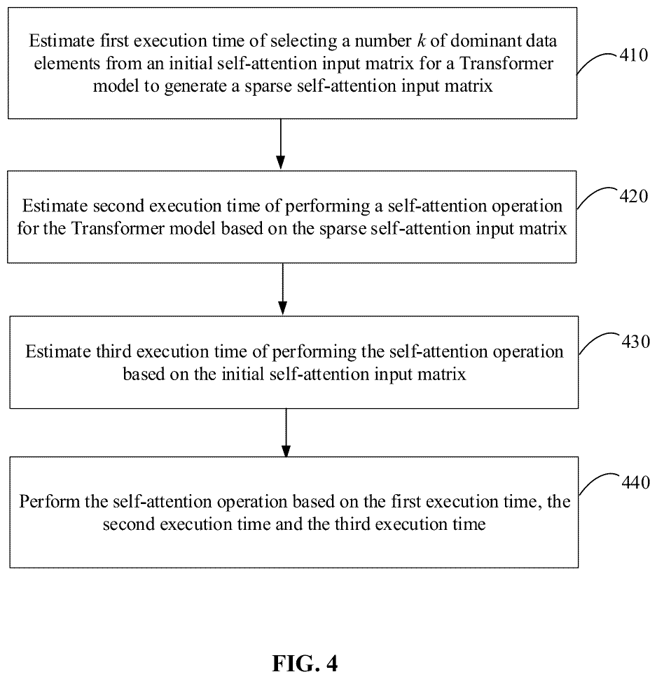

In order to illustrate an overall idea of the memory access adaptive self-attention mechanism for the Transformer model, an example procedure for implementing a memory access adaptive self-attention operation for a Transformer model according to some embodiments of the present disclosure will be described below with reference to FIG. 4. The procedure may be implemented by processor circuitry and may include operations 410 to 440.

At operation 410, the processor circuitry may estimate first execution time of selecting a number k of dominant data elements from an initial self-attention input matrix for a Transformer model to generate a sparse self-attention input matrix.

At operation 420, the processor circuitry may estimate second execution time of performing a self-attention operation for the Transformer model based on the sparse self-attention input matrix.

At operation 430, the processor circuitry may estimate third execution time of performing the self-attention operation based on the initial self-attention input matrix.

At operation 440, the processor circuitry may perform the self-attention operation based on the first execution time, the second execution time and the third execution time.

According to some embodiments, before performing the self-attention operation, the processor circuitry may determine a value of the number k for minimizing a sum of the first execution time and the second execution time under a condition that a preset accuracy of the self-attention operation is satisfied. In this case, the processor circuitry may perform the self-attention operation: performing the self-attention operation based on the sparse self-attention input matrix under a condition that the sum of the first execution time and the second execution time is less than the third execution time, or otherwise, performing the self-attention operation based on the initial self-attention input matrix.

According to some embodiments, the first execution time may include memory access time for data transfer between memory and registers and comparison time for data comparison.

According to some embodiments, the second execution time may include memory access time for data transfer between memory and registers and matrix multiplication time of matrix multiplication operations involved in the self-attention attention operation based on the sparse self-attention input matrix.

According to some embodiments, the third execution time may include memory access time for data transfer between memory and registers and matrix multiplication time of matrix multiplication operations involved in the self-attention attention operation based on the initial self-attention input matrix.

According to some embodiments, the initial self-attention input matrix may include a query matrix Q, a key matrix K and a value matrix V.

According to some embodiments, the number k may be greater than or equal to c×lnL_{Q}, where c is a constant sampling factor and L_{Q} is a row number of an input query matrix for the Transformer model.

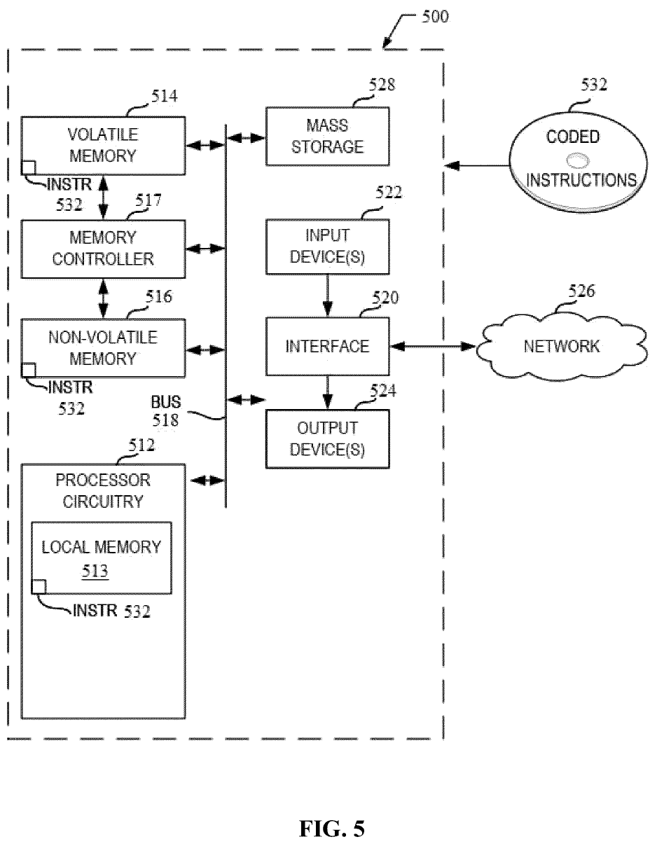

FIG. 5 is a block diagram of an example processor platform 500 structured to execute and/or instantiate machine readable instructions and/or operations to implement example procedures according to some embodiments of the present disclosure. The processor platform 500 can be, for example, a server, a personal computer, a workstation, a self-learning machine (e.g., a neural network), a mobile device (e.g., a cell phone, a smart phone, a tablet such as an iPad™), an Internet appliance, a DVD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 500 of the illustrated example includes processor circuitry 512. The processor circuitry 512 of the illustrated example is hardware. For example, the processor circuitry 512 can be implemented by one or more integrated circuits, logic circuits, FPGAs microprocessors, CPUs, GPUs, DSPs, and/or microcontrollers from any desired family or manufacturer. The processor circuitry 512 may be implemented by one or more semiconductor based (e.g., silicon based) devices.

The processor circuitry 512 of the illustrated example includes a local memory 513 (e.g., a cache, registers, etc.). The processor circuitry 512 of the illustrated example is in communication with a main memory including a volatile memory 514 and a non-volatile memory 516 by a bus 518. The volatile memory 514 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 516 may be implemented by flash memory and/or any other desired type of memory device. Access to the main memory 514, 516 of the illustrated example is controlled by a memory controller 517.

The processor platform 500 of the illustrated example also includes interface circuitry 520. The interface circuitry 520 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 522 are connected to the interface circuitry 520. The input device(s) 522 permit(s) a user to enter data and/or commands into the processor circuitry 512. The input device(s) 522 can be implemented by, for example, an audio sensor, a microphone, a camera (still or video), a keyboard, a button, a mouse, a touchscreen, a track-pad, a trackball, an isopoint device, and/or a voice recognition system.

One or more output devices 524 are also connected to the interface circuitry 520 of the illustrated example. The output devices 524 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 520 of the illustrated example, thus, typically includes a graphics driver card, a graphics driver chip, and/or graphics processor circuitry such as a GPU.

The interface circuitry 520 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 526. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 500 of the illustrated example also includes one or more mass storage devices 528 to store software and/or data. Examples of such mass storage devices 528 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 532 may be stored in the mass storage device 528, in the volatile memory 514, in the non-volatile memory 516, and/or on a removable non-transitory computer readable storage medium such as a CD or DVD.

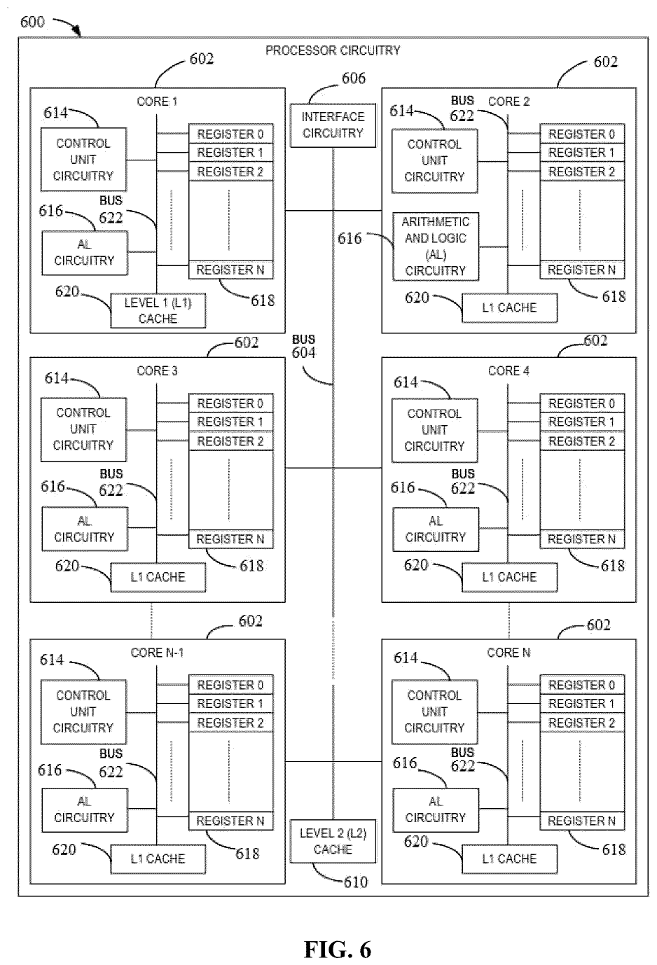

FIG. 6 is a block diagram of an example implementation of the processor circuitry 512 of FIG. 5. In this example, the processor circuitry 512 of FIG. 5 is implemented by a microprocessor 600. For example, the microprocessor 600 may implement multi-core hardware circuitry such as a CPU, a DSP, a GPU, an XPU, etc. Although it may include any number of example cores 602 (e.g., 1 core), the microprocessor 600 of this example is a multi-core semiconductor device including N cores. The cores 602 of the microprocessor 600 may operate independently or may cooperate to execute machine readable instructions. For example, machine code corresponding to a firmware program, an embedded software program, or a software program may be executed by one of the cores 602 or may be executed by multiple ones of the cores 602 at the same or different times. In some examples, the machine code corresponding to the firmware program, the embedded software program, or the software program is split into threads and executed in parallel by two or more of the cores 602. The software program may correspond to a portion or all of the machine readable instructions and/or operations discussed herein.

The cores 602 may communicate by an example bus 604. In some examples, the bus 604 may implement a communication bus to effectuate communication associated with one(s) of the cores 602. For example, the bus 604 may implement at least one of an Inter-Integrated Circuit (I2C) bus, a Serial Peripheral Interface (SPI) bus, a PCI bus, or a PCIe bus. Additionally or alternatively, the bus 604 may implement any other type of computing or electrical bus. The cores 602 may obtain data, instructions, and/or signals from one or more external devices by example interface circuitry 606. The cores 602 may output data, instructions, and/or signals to the one or more external devices by the interface circuitry 606. Although the cores 602 of this example include example local memory 620 (e.g., Level 1 (L1) cache that may be split into an L1 data cache and an L1 instruction cache), the microprocessor 600 also includes example shared memory 610 that may be shared by the cores (e.g., Level 2 (L2_cache)) for high-speed access to data and/or instructions. Data and/or instructions may be transferred (e.g., shared) by writing to and/or reading from the shared memory 610. The local memory 620 of each of the cores 602 and the shared memory 610 may be part of a hierarchy of storage devices including multiple levels of cache memory and the main memory (e.g., the main memory 614, 616 of FIG. 6). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 602 may be referred to as a CPU, DSP. GPU, etc., or any other type of hardware circuitry. Each core 602 includes control unit circuitry 614, arithmetic and logic (AL) circuitry (sometimes referred to as an ALU) 616, a plurality of registers 618, the L1 cache 620, and an example bus 622. Other structures may be present. For example, each core 602 may include vector unit circuitry, single instruction multiple data (SIMD) unit circuitry, load/store unit (LSU) circuitry, branch/jump unit circuitry, floating-point unit (FPU) circuitry, etc. The control unit circuitry 614 includes semiconductor-based circuits structured to control (e.g., coordinate) data movement within the corresponding core 602. The AL circuitry 616 includes semiconductor-based circuits structured to perform one or more mathematic and/or logic operations on the data within the corresponding core 602. The AL circuitry 616 of some examples performs integer based operations. In other examples, the AL circuitry 616 also performs floating point operations. In yet other examples, the AL circuitry 616 may include first AL circuitry that performs integer based operations and second AL circuitry that performs floating point operations. In some examples, the AL circuitry 616 may be referred to as an Arithmetic Logic Unit (ALU). The registers 618 are semiconductor-based structures to store data and/or instructions such as results of one or more of the operations performed by the AL circuitry 616 of the corresponding core 602. For example, the registers 618 may include vector register(s). SIMD register(s), general purpose register(s), flag register(s), segment register(s), machine specific register(s), instruction pointer register(s), control register(s), debug register(s), memory management register(s), machine check register(s), etc. The registers 618 may be arranged in a bank as shown in FIG. 6. Alternatively, the registers 618 may be organized in any other arrangement, format, or structure including distributed throughout the core 602 to shorten access time. The bus 620 may implement at least one of an I2C bus, a SPI bus, a PCI bus, or a PCIe bus.

Each core 602 and/or, more generally, the microprocessor 600 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 600 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

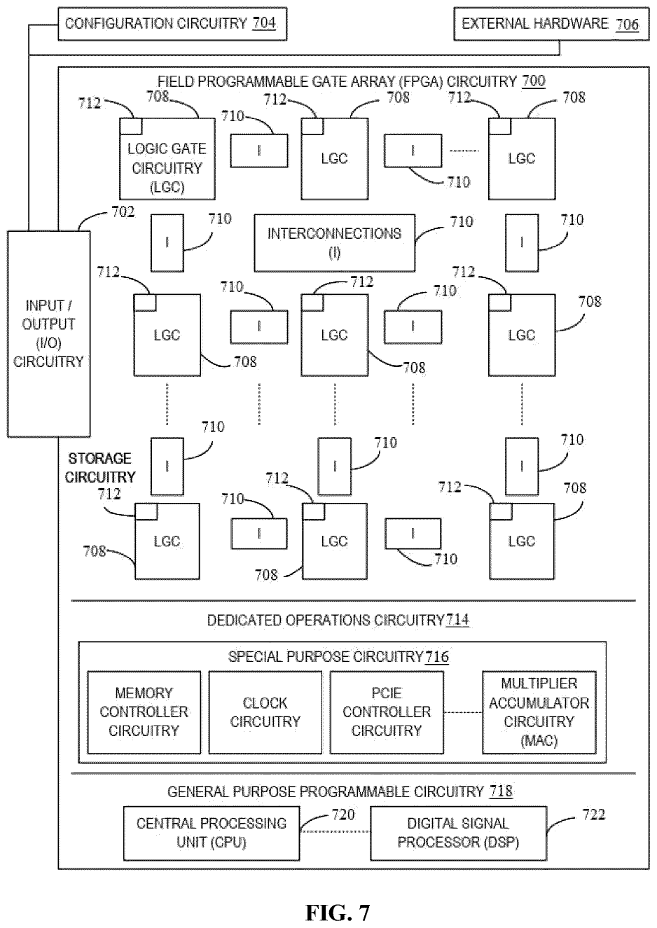

FIG. 7 is a block diagram of another example implementation of the processor circuitry 512 of FIG. 5. In this example, the processor circuitry 600 is implemented by FPGA circuitry 700. The FPGA circuitry 700 can be used, for example, to perform operations that could otherwise be performed by the example microprocessor 600 of FIG. 6 executing corresponding machine readable instructions. However, once configured, the FPGA circuitry 700 instantiates the machine readable instructions in hardware and, thus, can often execute the operations faster than they could be performed by a general purpose microprocessor executing the corresponding software.

More specifically, in contrast to the microprocessor 600 of FIG. 6 described above (which is a general purpose device that may be programmed to execute some or all of the operations disclosed herein but whose interconnections and logic circuitry are fixed once fabricated), the FPGA circuitry 700 of the example of FIG. 7 includes interconnections and logic circuitry that may be configured and/or interconnected in different ways after fabrication to instantiate. In particular, the FPGA 70) may be thought of as an array of logic gates, interconnections, and switches. The switches can be programmed to change how the logic gates are interconnected by the interconnections, effectively forming one or more dedicated logic circuits (unless and until the FPGA circuitry 700 is reprogrammed). The configured logic circuits enable the logic gates to cooperate in different ways to perform different operations on data received by input circuitry. Those operations may correspond to some or all of the software represented by the operations discussed herein. As such, the FPGA circuitry 700 may be structured to effectively instantiate some or all of the machine readable instructions representing the operations discussed herein as dedicated logic circuits to perform the operations corresponding to those software instructions in a dedicated manner analogous to an ASIC. Therefore, the FPGA circuitry 700 may perform the operations corresponding to the some or all of the operations discussed herein faster than the general purpose microprocessor can execute the same.

In the example of FIG. 7, the FPGA circuitry 700 is structured to be programmed (and/or reprogrammed one or more times) by an end user by a hardware description language (H-DL) such as Verilog. The FPGA circuitry 700 of FIG. 7, includes example input/output (I/O) circuitry 702 to obtain and/or output data to/from example configuration circuitry 704 and/or external hardware (e.g., external hardware circuitry) 706. For example, the configuration circuitry 704 may implement interface circuitry that may obtain machine readable instructions to configure the FPGA circuitry 700, or portion(s) thereof. In some such examples, the configuration circuitry 704 may obtain the machine readable instructions from a user, a machine (e.g., hardware circuitry (e.g., programmed or dedicated circuitry) that may implement an Artificial Intelligence/Machine Learning (AI/ML) model to generate the instructions) etc. In some examples, the external hardware 706 may implement the microprocessor 600 of FIG. 6. The FPGA circuitry 700 also includes an array of example logic gate circuitry 708, a plurality of example configurable interconnections 710, and example storage circuitry 712. The logic gate circuitry 708 and interconnections 710 are configurable to instantiate one or more operations discussed herein and/or other desired operations. The logic gate circuitry 708 shown in FIG. 7 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 708 to enable configuration of the electrical structures and/or the logic gates to form circuits to perform desired operations. The logic gate circuitry 708 may include other electrical structures such as look-up tables (LUTs), registers (e.g., flip-flops or latches), multiplexers, etc.

The interconnections 710 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 708 to program desired logic circuits.

The storage circuitry 712 of the illustrated example is structured to store result(s) of the one or more of the operations performed by corresponding logic gates. The storage circuitry 712 may be implemented by registers or the like. In the illustrated example, the storage circuitry 712 is distributed amongst the logic gate circuitry 708 to facilitate access and increase execution speed.

The example FPGA circuitry 700 of FIG. 7 also includes example Dedicated Operations Circuitry 714. In this example, the Dedicated Operations Circuitry 714 includes special purpose circuitry 716 that may be invoked to implement commonly used functions to avoid the need to program those functions in the field. Examples of such special purpose circuitry 716 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 700 may also include example general purpose programmable circuitry 718 such as an example CPU 720 and/or an example DSP 722. Other general purpose programmable circuitry 718 may additionally or alternatively be present such as a GPU, an XPU, etc., that can be programmed to perform other operations.

Although FIGS. 6 and 7 illustrate two example implementations of the processor circuitry 512 of FIG. 5, many other approaches are contemplated. For example, as mentioned above, modern FPGA circuitry may include an on-board CPU, such as one or more of the example CPU 720 of FIG. 7. Therefore, the processor circuitry 512 of FIG. 5 may additionally be implemented by combining the example microprocessor 600 of FIG. 6 and the example FPGA circuitry 700 of FIG. 7. In some such hybrid examples, a first portion of the machine readable instructions may be executed by one or more of the cores 602 of FIG. 6 and a second portion of the machine readable instructions may be executed by the FPGA circuitry 700 of FIG. 7.

In some examples, the processor circuitry 512 of FIG. 5 may be in one or more packages. For example, the processor circuitry 600 of FIG. 6 and/or the FPGA circuitry 700 of FIG. 7 may be in one or more packages. In some examples, an XPU may be implemented by the processor circuitry 512 of FIG. 5, which may be in one or more packages. For example, the XPU may include a CPU in one package, a DSP in another package, a GPU in yet another package, and an FPGA in still yet another package.

In various embodiments, the operations discussed herein may be implemented as hardware (e.g., logic circuitry), software, firmware, or combinations thereof, which may be provided as a computer program product, e.g., including one or more tangible (e.g., non-transitory) machine-readable or computer-readable media having stored thereon instructions (or software procedures) used to program a computer to perform a process discussed herein. The machine-readable medium may include a storage device.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Although embodiments have been described in language specific to structural features and/or methodological acts, it is to be understood that claimable subject matter may not be limited to the specific features or acts described. Rather, the specific features and acts are disclosed as sample forms of implementing the claimable subject matter.

### Additional Notes and Examples

Example 1 includes an apparatus, comprising: interface circuitry; and processor circuitry coupled to the interface circuitry and configured to: obtain an initial self-attention input matrix for a Transformer model received via the interface circuitry; estimate first execution time of selecting a number k of dominant data elements from the initial self-attention input matrix to generate a sparse self-attention input matrix; estimate second execution time of performing a self-attention operation for the Transformer model based on the sparse self-attention input matrix; estimate third execution time of performing the self-attention operation based on the initial self-attention input matrix; and perform the self-attention operation based on the first execution time, the second execution time and the third execution time.
Example 2 includes the apparatus of Example 1, wherein before performing the self-attention operation, the processor circuitry is further configured to: determine a value of the number k for minimizing a sum of the first execution time and the second execution time under a condition that a preset accuracy of the self-attention operation is satisfied.
Example 3 includes the apparatus of Example 2, wherein the processor circuitry is configured to perform the self-attention operation by: performing the self-attention operation based on the sparse self-attention input matrix under a condition that the sum of the first execution time and the second execution time is less than the third execution time, or otherwise, performing the self-attention operation based on the initial self-attention input matrix.
Example 4 includes the apparatus of any of Examples 1 to 3, wherein the first execution time comprises memory access time for data transfer between memory and registers and comparison time for data comparison.
Example 5 includes the apparatus of any of Examples 1 to 4, wherein the second execution time comprises memory access time for data transfer between memory and registers and matrix multiplication time of matrix multiplication operations involved in the self-attention attention operation based on the sparse self-attention input matrix.
Example 6 includes the apparatus of any of Examples 1 to 5, wherein the third execution time comprises memory access time for data transfer between memory and registers and matrix multiplication time of matrix multiplication operations involved in the self-attention attention operation based on the initial self-attention input matrix.
Example 7 includes the apparatus of any of Examples 1 to 6, wherein the initial self-attention input matrix comprises a query matrix Q, a key matrix K and a value matrix V.
Example 8 includes the apparatus of any of Examples 1 to 7, wherein the number k is greater than or equal to c×lnL_{Q}, where c is a constant sampling factor and L_{Q} is a row number of an input query matrix for the Transformer model.
Example 9 includes a method, comprising: estimating first execution time of selecting a number k of dominant data elements from an initial self-attention input matrix for a Transformer model to generate a sparse self-attention input matrix; estimating second execution time of performing a self-attention operation for the Transformer model based on the sparse self-attention input matrix; estimating third execution time of performing the self-attention operation based on the initial self-attention input matrix; and performing the self-attention operation based on the first execution time, the second execution time and the third execution time.
Example 10 includes the method of Example 9, wherein before performing the self-attention operation, the method further comprises: determining a value of the number k for minimizing a sum of the first execution time and the second execution time under a condition that a preset accuracy of the self-attention operation is satisfied.
Example 11 includes the method of Example 10, wherein performing the self-attention operation comprises: performing the self-attention operation based on the sparse self-attention input matrix under a condition that the sum of the first execution time and the second execution time is less than the third execution time, or otherwise, performing the self-attention operation based on the initial self-attention input matrix.
Example 12 includes the method of any of Examples 9 to 11, wherein the first execution time comprises memory access time for data transfer between memory and registers and comparison time for data comparison.
Example 13 includes the method of any of Examples 9 to 12, wherein the second execution time comprises memory access time for data transfer between memory and registers and matrix multiplication time of matrix multiplication operations involved in the self-attention attention operation based on the sparse self-attention input matrix.
Example 14 includes the method of any of Examples 9 to 13, wherein the third execution time comprises memory access time for data transfer between memory and registers and matrix multiplication time of matrix multiplication operations involved in the self-attention attention operation based on the initial self-attention input matrix.
Example 15 includes the method of any of Examples 9 to 14, wherein the initial self-attention input matrix comprises a query matrix Q, a key matrix K and a value matrix V.
Example 16 includes the method of any of Examples 9 to 15, wherein the number k is greater than or equal to c×lnL_{Q}, where c is a constant sampling factor and L) is a row number of an input query matrix for the Transformer model.
Example 17 includes a computer-readable medium having instructions stored thereon, wherein the instructions, when executed by processor circuitry, cause the processor circuitry to perform any method of Examples 9 to 16.
Example 18 includes an apparatus, comprising means for performing any method of Examples 9 to 16.

Various techniques, or certain aspects or portions thereof, may take the form of program code (i.e., instructions) embodied in tangible media, such as floppy diskettes, CD-ROMs, hard drives, non-transitory computer readable storage medium, or any other machine-readable storage medium, wherein, when the program code is loaded into and executed by a machine, such as a computer, the machine becomes an apparatus for practicing the various techniques. The non-transitory computer readable storage medium may be a computer readable storage medium that does not include signal. In the case of program code execution on programmable computers, the computing system may include a processor, a storage medium readable by the processor (including volatile and non-volatile memory and/or storage elements), at least one input device, and at least one output device. The volatile and non-volatile memory and/or storage elements may be a RAM, EPROM, flash drive, optical drive, magnetic hard drive, solid state drive, or other medium for storing electronic data. One or more programs that may implement or utilize the various techniques described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations. Exemplary systems or devices may include without limitation, laptop computers, tablet computers, desktop computers, smart phones, computer terminals and servers, storage databases, and other electronics which utilize circuitry and programmable memory, such as household appliances, smart televisions, digital video disc (DVD) players, heating, ventilating, and air conditioning (HVAC) controllers, light switches, and the like.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first.” “second.” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1. An apparatus, comprising:
interface circuitry; and
processor circuitry coupled to the interface circuitry and configured to:
obtain an initial self-attention input matrix for a Transformer model received via the interface circuitry;
estimate first execution time of selecting a number k of dominant data elements from the initial self-attention input matrix to generate a sparse self-attention input matrix;
estimate second execution time of performing a self-attention operation for the Transformer model based on the sparse self-attention input matrix;
estimate third execution time of performing the self-attention operation based on the initial self-attention input matrix; and
perform the self-attention operation based on the first execution time, the second execution time and the third execution time.

2. The apparatus of claim 1, wherein before performing the self-attention operation, the processor circuitry is further configured to:
determine a value of the number k for minimizing a sum of the first execution time and the second execution time under a condition that a preset accuracy of the self-attention operation is satisfied.

3. The apparatus of claim 2, wherein the processor circuitry is configured to perform the self-attention operation by:
performing the self-attention operation based on the sparse self-attention input matrix under a condition that the sum of the first execution time and the second execution time is less than the third execution time, or otherwise, performing the self-attention operation based on the initial self-attention input matrix.

4. The apparatus of claim 1, wherein the first execution time comprises memory access time for data transfer between memory and registers and comparison time for data comparison.

5. The apparatus of claim 1, wherein the second execution time comprises memory access time for data transfer between memory and registers and matrix multiplication time of matrix multiplication operations involved in the self-attention attention operation based on the sparse self-attention input matrix.

6. The apparatus of claim 1, wherein the third execution time comprises memory access time for data transfer between memory and registers and matrix multiplication time of matrix multiplication operations involved in the self-attention attention operation based on the initial self-attention input matrix.

7. The apparatus of claim 1, wherein the initial self-attention input matrix comprises a query matrix Q, a key matrix K and a value matrix V.

8. The apparatus of claim 1, wherein the number k is greater than or equal to c×lnL_{Q}, where c is a constant sampling factor and L_{Q} is a row number of an input query matrix for the Transformer model.

9. A method, comprising:
estimating first execution time of selecting a number k of dominant data elements from an initial self-attention input matrix for a Transformer model to generate a sparse self-attention input matrix;
estimating second execution time of performing a self-attention operation for the Transformer model based on the sparse self-attention input matrix;
estimating third execution time of performing the self-attention operation based on the initial self-attention input matrix; and
performing the self-attention operation based on the first execution time, the second execution time and the third execution time.

10. The method of claim 9, wherein before performing the self-attention operation, the method further comprises:
determining a value of the number k for minimizing a sum of the first execution time and the second execution time under a condition that a preset accuracy of the self-attention operation is satisfied.

11. The method of claim 10, wherein performing the self-attention operation comprises:
performing the self-attention operation based on the sparse self-attention input matrix under a condition that the sum of the first execution time and the second execution time is less than the third execution time, or otherwise, performing the self-attention operation based on the initial self-attention input matrix.

12. The method of claim 9, wherein the first execution time comprises memory access time for data transfer between memory and registers and comparison time for data comparison.

13. The method of claim 9, wherein the second execution time comprises memory access time for data transfer between memory and registers and matrix multiplication time of matrix multiplication operations involved in the self-attention attention operation based on the sparse self-attention input matrix.

14. The method of claim 9, wherein the third execution time comprises memory access time for data transfer between memory and registers and matrix multiplication time of matrix multiplication operations involved in the self-attention attention operation based on the initial self-attention input matrix.

15. The method of claim 9, wherein the initial self-attention input matrix comprises a query matrix Q, a key matrix K and a value matrix V.

16. The method of claim 9, wherein the number k is greater than or equal to c×lnL_{Q}, where c is a constant sampling factor and L_{Q} is a row number of an input query matrix for the Transformer model.

17. (canceled)

18. (canceled)

19. At least one non-transitory computer readable medium comprising instructions that cause at least one processor to at least:
obtain an initial self-attention input matrix for a Transformer model received via the interface circuitry;
estimate first execution time of selecting a number k of dominant data elements from the initial self-attention input matrix to generate a sparse self-attention input matrix;
estimate second execution time of performing a self-attention operation for the Transformer model based on the sparse self-attention input matrix;
estimate third execution time of performing the self-attention operation based on the initial self-attention input matrix; and
perform the self-attention operation based on the first execution time, the second execution time and the third execution time.

20. The at least one non-transitory computer readable medium of claim 19, wherein before performance of the self-attention operation, one or more of the at least one processor is to:
determine a value of the number k for minimizing a sum of the first execution time and the second execution time under a condition that a preset accuracy of the self-attention operation is satisfied.

21. The at least one non-transitory computer readable medium of claim 20, wherein one or more of the at least one processor is to perform the self-attention operation based on the sparse self-attention input matrix under a condition that the sum of the first execution time and the second execution time is less than the third execution time, or otherwise, performing the self-attention operation based on the initial self-attention input matrix.

22. The at least one non-transitory computer readable medium of claim 19, wherein the first execution time includes memory access time for data transfer between memory and registers and comparison time for data comparison.
